(19) United States
(12) Patent Application Publication
(10) Pub. No.: US 2026/0295968 A1
(43) Pub. Date: Oct. 1, 2026

(54) Reinforced Foam Structure

(71) Applicant: Daikin Applied Americas, Inc., Minneapolis, MN (US)

(72) Inventors: Brent A. Johnski, Minnetrista, MN (US); Jeremy M. Small, Plymouth, MN (US); James Scott Grega, Plymouth, MN (US)

(73) Assignee: Daikin Applied Americas, Inc., Minneapolis, MN (US)

(21) Appl. No.: 19/097,482

(22) Filed: Apr. 1, 2025

(51) Int. Cl. B32B 5/18; F16L 59/02

(52) U.S. Cl. CPC B32B 5/18; F16L 59/029; B32B 2260/02; B32B 2260/04; B32B 2266/06; B32B 2266/08; B32B 2307/304; B32B 2607/00

(57) ABSTRACT

A system and apparatus for a reinforced foam structure for use in an HVAC system is disclosed. The structure includes a composite material and a skin layer covering at least apportion of the composite material. The composite material includes an open cell substrate and a closed cell foam expanded within at least one or more of the open cells of the substrate. The closed cell foam is expanded within at least one or more of the open cells of the substrate and provides the composite material with greater compressive strength than the open cell substrate without the closed cell foam.

### BACKGROUND

This section is intended to introduce the reader to various aspects of the art that may be related to various aspects of the presently described embodiments—to help facilitate a better understanding of various aspects of the present embodiments. Accordingly, it should be understood that these statements are to be read in this light, and not as admissions of prior art.

In general, heating, ventilation, and air-conditioning (“HVAC”) systems circulate an indoor space's air over low-temperature (for cooling) or high-temperature (for heating) sources, thereby adjusting an indoor space's air temperature and humidity. HVAC systems generate these low-and high-temperature sources by, among other techniques, taking advantage of a well-known physical principle: a fluid transitioning from gas to liquid releases heat, while a fluid transitioning from liquid to gas absorbs heat.

HVAC equipment is commonly housed in an insulated enclosure, such as a cabinet of an air handler unit (“AHU”). The cabinet directs air through the equipment and provides shelter to the components housed within. Due to the redirection of air and an effect from certain components of the HVAC process, high positive and negative pressure differential sections are created throughout the cabinet. The HVAC equipment can be located in many different climate conditions, so the cabinet may be thermally insulated to prevent heat loss or gain between the treated interior air and the exterior air.

Conventional HVAC cabinets are created using panels comprised of external sheet metal surfaces, e.g., skin layers or cladding, and foam insulation cores. The conventional cabinets including these conventional panels are subject to thermal bridging. Thermal bridging is the movement of heat across an object that is more conductive than the materials around the object. While the center of the conventional panel has a very low thermal transmittance value (because of the foam insulation core), the outer edge of the panel (where the sheet metal wraps the edge of the panel) can carry a larger thermal load from the inside of the cabinet to the outside of the cabinet, which lowers the overall R-value of the cabinet and can even cause condensation buildup on the edges of the panels. The R-value is a measure of thermal resistance, and the greater the insulating effectiveness, the larger the R-value. The outer edge of the conventional panel provides a thermal bridge that provides a low resistance path for heat flow, which lowers the insulating effectiveness of the conventional panel and the cabinet including such panels.

When preparing panels for AHUs, expanding closed cell foam is injected into a sheet metal frame. This results in a foam panel with cladding which provides reasonable thermal insulation and structural strength. However, the closed cell injection foam in and of itself does not have significant strength and does not allow for screws to fasten to the foam. The strength comes from the foam bonding to the steel of the liner, but this still does not improve the strength when fasteners attach to the foam.

Thus, anchor points are often necessary to provide adequate strength to the panels, but this requires specialty hardware not always readily available. Currently, the use of heavier gauge sheet metal and/or mechanical inserts (i.e. Rivnuts, weldnuts), or specialty fasteners are used to attach components (via fasteners) to foam panels. Additional support structure is typically added under a panel to support the panel, but to prevent a panel from compressing when fasteners are used, internal components would be added. The material of the internal components should not conduct heat (thereby making a thermal channel from the interior to the exterior of the panel) and typically adds weight to the panel, often creating inefficient and cumbersome designs.

### SUMMARY

Certain aspects of one or more embodiments disclosed herein are set forth below. It should be understood that these aspects are presented merely to provide the reader with a brief summary of certain forms the invention might take and that these aspects are not intended to limit the scope of the invention. Indeed, the invention may encompass a variety of aspects that may not be set forth below.

Embodiments of the present disclosure generally relate to a structure having an open cell substrate and a closed cell foam disposed within the open cell substrate to create a strengthened composite material while maintaining the thermally insulative and lightweight features the foam provides.

Accordingly, a need exists for a strengthening structure for a panel that does not add significant weight to an AHU.

Further, a need exists for a strengthening structure for a panel that allows for the insertion of fasteners.

Various refinements of the features noted above may exist in relation to various aspects of the present embodiments. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. Again, the brief summary presented above is intended only to familiarize the reader with certain aspects and contexts of one or more embodiments without limitation to the claimed subject matter.

### BRIEF DESCRIPTION OF THE DRAWINGS

These and other features, aspects, and advantages of certain embodiments will become better understood when the following detailed description is read with reference to the accompanying drawings in which like characters represent like parts throughout the drawings.

FIG. 1 is a perspective view of an AHU, according to one or more aspects of the present disclosure.

FIG. 2 is a perspective view of a frame structure of the AHU of FIG. 1, according to one or more aspects of the present disclosure.

FIG. 3 is a front elevational view of the frame structure of FIG. 2, according to one or more aspects of the present disclosure.

FIG. 4A is a side plan view of a section of reinforced foam structure, according to one or more aspects of the present disclosure.

FIG. 4B is an isometric view of a section of reinforced foam structure, according to one or more aspects of the present disclosure.

FIG. 4C is a cross-section view of a reinforced foam structure having a closed cell foam injected into an open cell substrate, according to one or more aspects of the present disclosure.

FIG. 5A is an exemplary open cell substrate, according to one or more aspects of the present disclosure.

FIG. 5B is an exemplary open cell substrate, according to one or more aspects of the present disclosure.

FIG. 5C are exemplary open cell substrates, according to one or more aspects of the present disclosure.

FIG. 5D is an exemplary open cell substrate, according to one or more aspects of the present disclosure.

FIG. 6 illustrates open cell substrates having varying numbers of open cells per inch, according to one or more aspects of the present disclosure.

FIG. 7 illustrates exemplary open cell geometric patterns, according to one or more aspects of the present disclosure.

FIG. 8A is a cross-section view of a panel assembly, according to one or more aspects of the present disclosure.

FIG. 8B is a cross-section view of a panel assembly for use as a mounting point, according to one or more aspects of the present disclosure.

FIG. 8C is a cross-section view of a heat dissipating panel assembly, according to one or more aspects of the present disclosure.

### DETAILED DESCRIPTION

One or more specific embodiments of the present disclosure will be described below. In an effort to provide a concise description of these embodiments, not all features of an actual implementation may be described. It should be appreciated that in the development of any such actual implementation, as in any engineering or design project, numerous implementation-specific decisions must be made to achieve the developers'specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

The present disclosure relates to a reinforced composite material structure providing thermally insulative and lightweight features. Specifically, the composite material includes an open cell matrix impregnated with expanding closed cell foam that is at least partially covered by an external skin or cladding layer. The open cell matrix may be polymer foam or mesh, steel foam or wool, expanded aluminum, copper or other metals, rubber foam, a combination of multiple materials. When the composite material is configured with a skin layer as a panel, this results in a lightweight, strong, and insulated panel that can have fasteners attached directly to the panel without additional reinforcing components. Additionally, the added strength from the composite material allows for the use a thinner gauge of cladding, thereby reducing the total weight of the panel.

While the example apparatus and systems are disclosed herein as operating with AHUs for use in an HVAC system, this distinction is purely exemplary and it should be appreciated that the apparatus and systems may be operable in other applications. For example, the apparatus and systems may be utilized in the automotive, aerospace, and transportation industries. Alternatively, the apparatus and systems can be used in refrigeration, lightweight construction material, impact resistant material, self-expanding shipping foam materials, vehicle paneling, sound reduction, crash absorption, boating materials, and garage door applications. The reinforced foam structure can be utilized in any application that includes temperature differences across a medium. Prefabrication may be useful in applications where the composite material is selectively required.

The open cell substrate includes a matrix structure defining a plurality of open cells (apertures). The matrix structure of the open cell substrate includes a variety of configurations including foams, meshes, grids, lattices, webs, pockets, voids, and crosslinking and perforated materials. The open cell substrate may be any material capable of impregnation by a closed cell foam and suitable to provide the matrix structure and adequate tensile strength. For example, the open cell substrate may be a foam, mesh, or grid. Some additional open cell substrate examples include polymer foam or mesh, steel foam or wool, expanded aluminum, copper or other metals, rubber foam, or a combination of multiple materials. Depending on the material, the open cell substrate may be resilient and flexible. In one or more embodiments, multiple open cell substrates are provided.

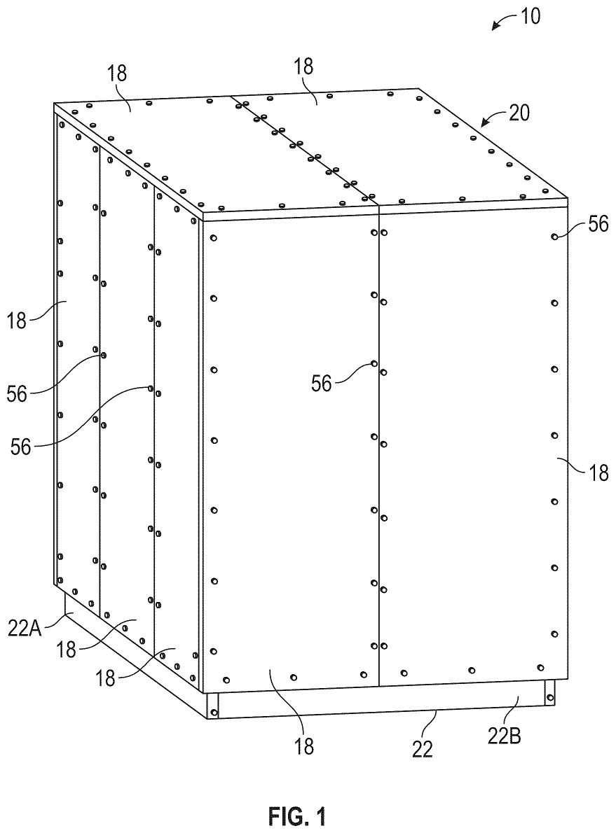

Referring now to FIG. 1, an AHU 10 is shown in an isometric view, respectively with one or more of the components of the AHU 10 removed for clarity. The example AHU 10 is a so-called light commercial packaged rooftop unit and shall be described in terms of a cooling operation, although it should be appreciated that the AHU 10 could also be a heat pump and used for heating. Additionally, the AHU 10 may also represent residential packaged, residential split, light commercial split, or commercial applied applications as well as refrigeration system applications. The AHU 10 may be utilized for indoor or outdoor applications.

As shown in FIGS. 1-3, a base 22 of the frame structure 16 supports the air handler cabinet 20 on the ground. The frame structure 16 includes a plurality of first frame members 12 and a plurality of second frame members 14. The first frame members 12 allow two panel assemblies 18 to be connected substantially perpendicularly to one another, such as at a corner of the cabinet 20. The second frame members 14 allow two panel assemblies 18 to be connected substantially parallel to one another, such as side-by-side on a same side of the cabinet 20.

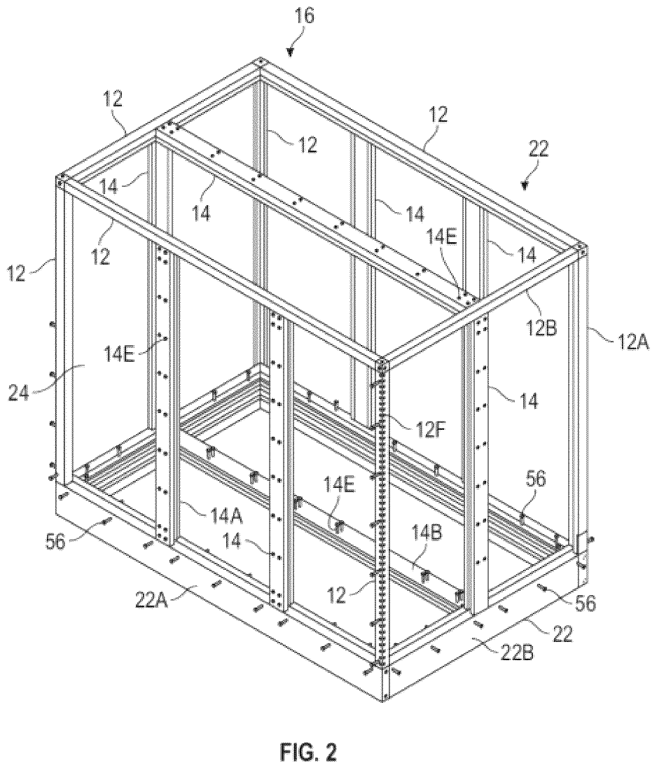

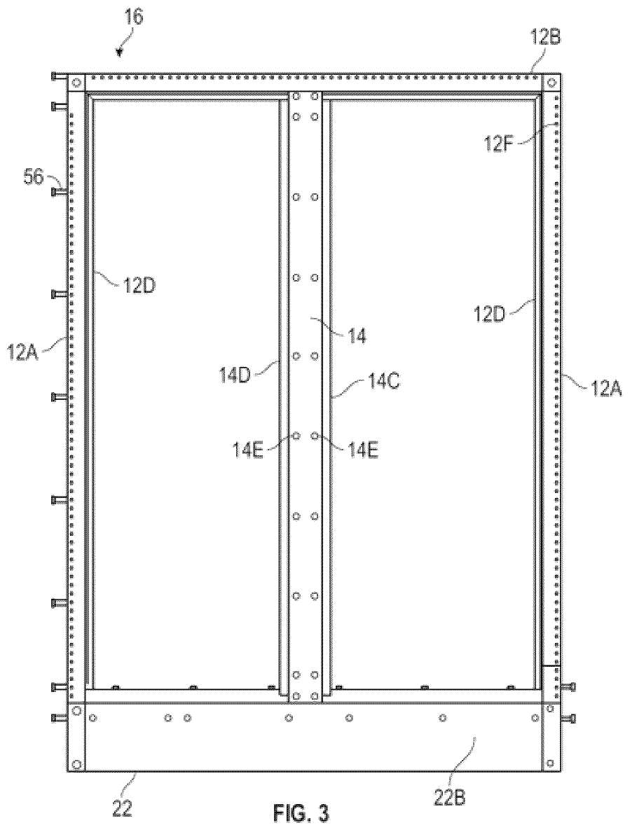

With reference to the orientation shown in FIGS. 1-3, the plurality of first frame members 12 include vertical first frame members 12A and horizontal first frame members 12B, as shown in FIG. 2. The vertical first frame members 12A extend vertically from each corner of the base 22. The lower ends of the vertical frame members 12A are connected to the base 22 in any suitable manner, such as with fasteners 56. The horizontal first frame members 12B extend horizontally between upper ends of adjacent vertical first frame members 12A. The horizontal first frame members 12B are connected to the vertical first frame members 12A in any suitable manner, such as with fasteners 56. The first and second flanges 12C and 12D may include a plurality of fastener openings (not shown) to facilitate connecting the second frame members 14. The first and second flanges 12C and 12D may be substantially perpendicular to one another such that the panel assemblies 18 connected thereto are disposed perpendicularly to one another. The first and second flanges 12C and 12D further support the installed panel assemblies 18. A gasket (not shown) can be disposed on the first and second flanges 12C and 12D to provide an air seal. The first frame members 12 include a plurality of fastener holes 12F, as shown in FIGS. 2 and 3, to facilitate connecting the panel assemblies 18 thereto. In one or more embodiments, the plurality of fastener openings (not shown) do not extend entirely through the first frame members 12.

The second frame members 14 include vertical second frame members 14A and horizontal second frame members 14B, as shown in FIG. 2. The vertical second frame members 14A extend vertically between the base 22 and the horizontal first frame members 12B, as shown in FIGS. 2 and 3. The lower ends of the vertical second frame members 14A are connected to the base 22 in any suitable manner, such as with fasteners 56. The upper ends of the vertical second frame members 14A are connected to the horizontal first frame members 12B, such as to a flange 12D. The horizontal second frame members 12B extend horizontally. A lower horizontal second frame member 14B extends between opposite sides of the base 22. An upper horizontal second frame member 14B extends between oppositely disposed horizontal first frame members 12B. The horizontal second frame members 14B are connected in any suitable manner, such as with fasteners 56. Each of the second frame members 14 has first and second flanges 14C and 14D, as shown in FIG. 3. The first and second flanges 12C and 12D support the installed panel assemblies 18. A gasket (not shown) can be disposed on the first and second flanges 14C and 14D to provide an air seal. The second frame members 14 include a plurality of fastener holes 14E to facilitate connecting the panel assemblies 18 thereto. The plurality of fastener holes 14E preferably do not extend entirely through the second frame members 14. The first and second flanges 14A and 14B are substantially parallel to one another such that the panel assemblies 18 connected thereto are disposed substantially parallel to one another, such as between two adjacent panel assemblies on the same side of the cabinet, as shown in FIG. 1.

The panel assemblies 18 are connected to the first frame members 12, the second frame members 14 and/or the base 22, as shown in FIG. 1, based on the position of the panel assembly 18. In one or more embodiments, the base 22 is substantially rectangular and has a first side 22A and a second side 22B. The first side 22A is longer than the second side 22B, although the base can have any suitable configuration, such as being substantially square. As shown in the embodiment of FIG. 1, each of the first sides 22A of the base 22 has three panel assemblies 18 connected thereto, and each of the second sides 22B of the base 22 has two panel assemblies 18 connected thereto. The top side of the cabinet 20 has two panel assemblies 18, and the bottom side of the cabinet 20 has two panel assemblies 18, as shown in FIG. 1. The embodiment of cabinet 20 illustrated in FIG. 1 has fourteen panel assemblies 18, although the cabinet can have any suitable number of panel assemblies in accordance with the exemplary embodiments of the present invention.

In some embodiments, the present invention may be applied in panel-to-panel construction. For clarity, some AHUs are frameless by design. In such embodiments, individual panels are configured to connect directly to each other rather than to a frame member. Typically, a foam gasket or other insulating material is positioned between adjacent panels to provide a thermal break. Frameless AHUs are more commonly used with applications which do not require the additional structural support provided by an AHU frame.

According to one or more embodiments of the present disclosure, the composite material is a closed cell foam injected into an open cell substrate for preparing panel assemblies 18 in AHUs 10, such as those illustrated in FIGS. 1-3.

In one or more embodiments, an insulated panel includes a preformed piece of solid open cell foam substrate covered by a first cladding (i.e., an external skin layer) and a second cladding covered atop the open cell foam substrate, thereby substantially containing the solid open cell substrate between the first and second cladding to form a panel. Then a liquid expanding closed cell foam is injected through the cladding and allowed to expand to fill the voids of the open cell foam substrate. In one or more embodiments, a press may be used to prevent the expanding closed cell foam from displacing the cladding. As the liquid closed cell foam expands, it fills the voids of the open cell foam until the pressure of the expanding closed cell foam dissipates. It will be appreciated that the skin layer may create a thermal insulator.

One specific embodiment is an AHU panel assembly made with steel cladding that is less than about 20 mm thick, preferably about 15 mm thick. 15 mm steel cladding is typically not strong enough to be used in an insulated AHU panel because the pressures created inside the AHU would deform the panel. The use of a stronger composite material insulation, as described herein, results in an HVAC panel strong enough to support AHU operations. In one or more embodiments, an AHU panel is created using steel cladding about 10 mm thick with a composite material insulation. In one or more embodiments, an AHU panel is created using steel cladding about 5 mm thick with a composite material insulation. In one or more embodiments, the external cladding of an AHU panel is a foil. In one or more embodiments, the external cladding of an AHU panel is a polymer sheet. In one or more embodiments, the composite material replaces the steel cladding of a panel assembly entirely.

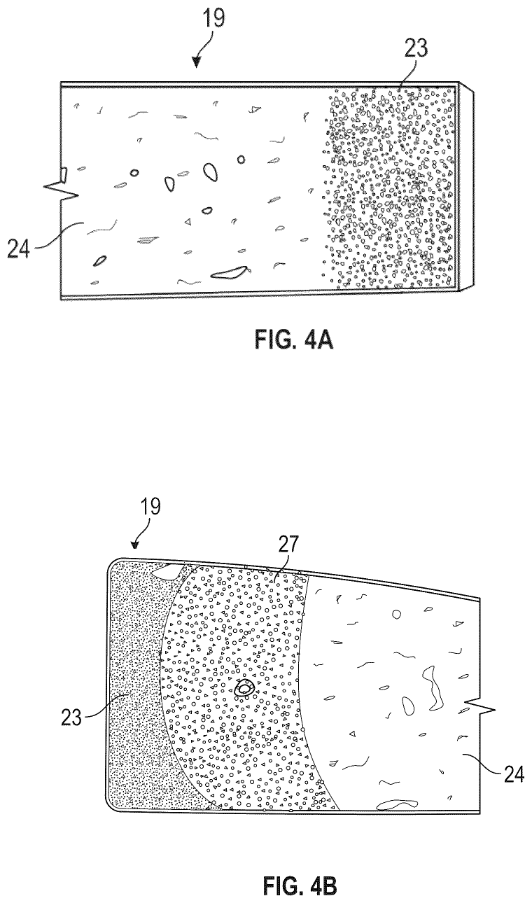

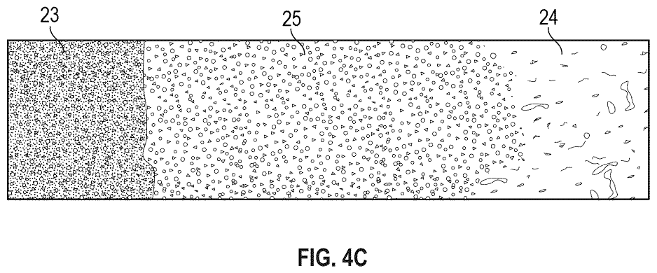

FIG. 4A illustrates a reinforced panel assembly including a skin layer 19, an open cell substrate 23, and a closed cell foam 24, in accordance with one or more embodiments. The skin layer 19 covers at least one surface of the structure, though FIG. 4A merely illustrates one end of the structure. The closed cell foam 24 has not impregnated the open cell substrate 23 as evidenced by the closed cell foam 24 expanded along the left side of FIG. 4A and abruptly stopping along a length of the structure, leaving open cell substrate cells 23 exposed. In this embodiment, the closed cell foam 24 has not formed a strong composite material such as that shown in FIG. 4B which could be due to a variety of factors such as low viscosity of the closed cell foam or insufficient cure times.

The structure of FIG. 4B includes a skin layer 19 and a closed cell foam 24 injected into an open cell substrate 23, in accordance with one or more embodiments. The area in the open cell substrate 23 impregnated by the closed cell foam 24 creates a strong composite material 27. The open cell substrate 23 functions similar to rebar in concrete and provides structure to keep the closed cell foam 24 from breaking. The open cell substrate 23 material is less brittle compared to the closed cell foam 24 and can flex at least slightly. The composite material 27 has the benefits of being more rigid than the open cell substrate 23 by itself, but not brittle due to the open cell substrate 23 reinforcing the expanded closed cell foam 24. As described further below, the closed cell foam 24 itself may be brittle and does not allow for screws to fasten to the closed cell foam 24. In one or more embodiments, a panel made using the disclosed composite material will have additional strength compared to either the open cell substrate 23 or the closed cell foam 24 by themselves due to the closed cell foam chemically bonding to the steel of the liner or cladding. FIG. 4C illustrates a similar and closer view of the impregnation of FIG. 4B omitting the skin layer for clarity.

In one or more embodiments, multiple injection sites may be used to inject liquid expanding closed cell foam to maintain a more even distribution of closed cell foam within the voids of the open cell foam. In one or more embodiments, the closed cell foam may be injected through cladding. Once the closed cell foam cures, a composite material is created by the cured closed cell foam contained within the voids of the open cell foam. In one or more embodiments, this composite material has a greater compressive strength than the open cell foam and is less brittle than the closed cell foam. In one or more embodiments, the cured closed cell foam serves to reinforce the open cell foam contained within the cladding to create a stronger or more rigid panel. In one or more embodiments, the composite material is strong enough to hold fasteners, thereby reducing the need for additional supporting structures designed to hold fasteners.

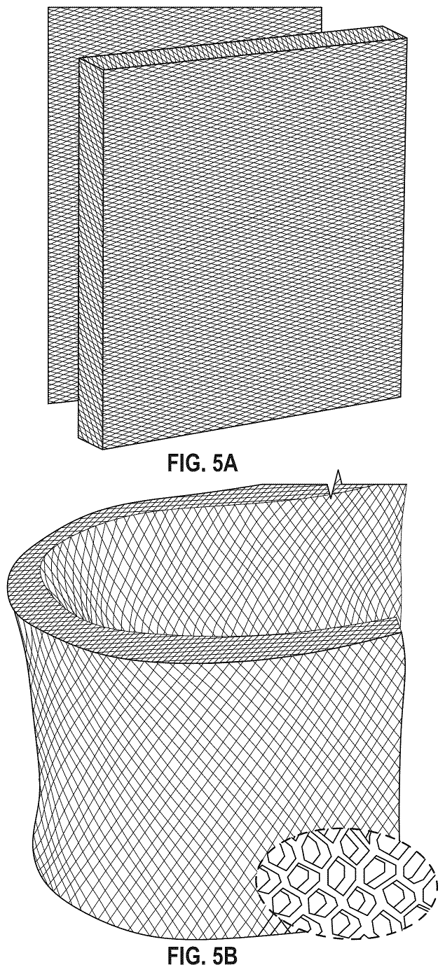

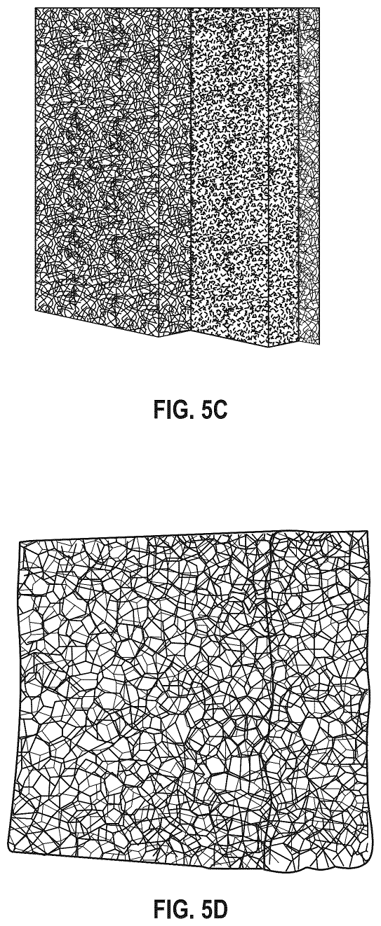

FIG. 5A-D illustrate exemplary open cell substrates. FIG. 5A illustrates a multilayer mesh having equal-sized, diamond-shaped open cells. FIG. 5B illustrates a multilayer mesh having equal-sized, honeycomb-shaped open cells. FIGS. 5C and 5D illustrate multilayer meshes having different-sized, different-shaped random open cells.

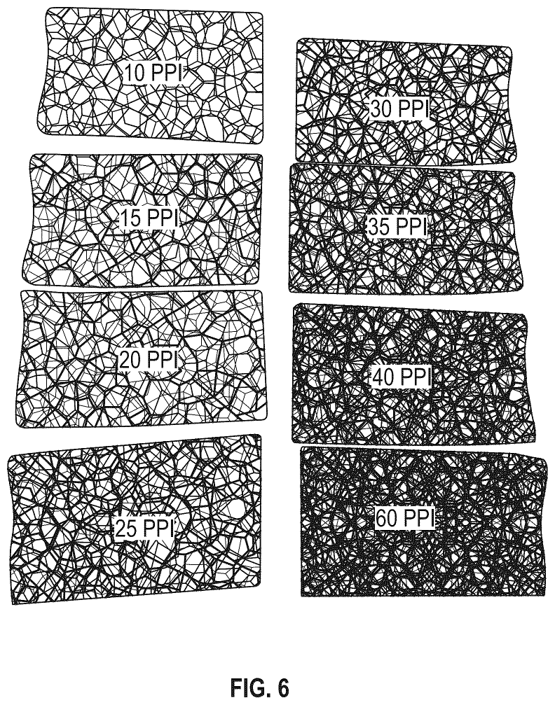

The matrix structure may be defined by density of the open cells. One such measurement is the number of open cells, or parts, per inch (“PPI”). FIG. 6 illustrates a variety of open cell substrates with matrix structures ranging from 10 PPI to 60 PPI. Lower PPI values reflect less dense matrix structures whereas higher PPI values reflect more dense matrix structures. It should be appreciated that open cell substrates may also have PPI values below 10 or above 60. In one or more embodiments, lower density (i.e., lower PPI) cell structures may be preferred to ensure the closed cell foam has sufficient contact with the open cell substrate to benefit strength of the composite material.

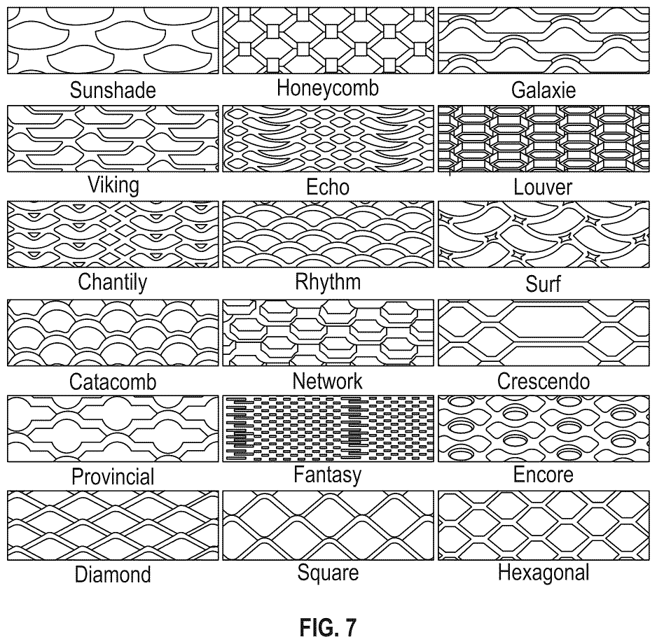

The open cells of the substrate may be homogenous or heterogenous in size from one another. The matrix structure may consist of repeating patterns as shown in FIG. 7. FIG. 7 provides eighteen exemplary patterns of the open cells of the matrix structure including sunshade, honeycomb, galaxie, viking, echo, louver, chantily, rhythm, surf, catacomb, network, crescendo, provincial, fantasy, encore, diamond, square, and hexagonal. It should be appreciated that the repeating open cell patterns of FIG. 7 are purely exemplary and other patterns may be added, omitted, or utilized in combination with other patterns. Alternatively, in other embodiments such as those of FIGS. 5C and 6, the open cells do not provide any pattern.

Returning again to FIG. 4B, closed cell foam 24 is impregnated into the open cell substrate 23. In one or more embodiments, the closed cell foam chemically adheres to both the open cells within the open cell substrate and the panel assembly, forming a bond and providing thermal and structural advantages to the reinforced foam structure. The physical, thermal, and electrical properties of the open cell substrate and the closed cell foam influence the compressive strength, tensile strength, toughness, hardness, impact resistance, conductivity, thermal transfer, and energy absorption of the resulting reinforced foam structure. In one or more embodiments, the reinforced foam structure has a greater compressive strength than the open cell foam otherwise does absent the expanded closed cell foam. In one or more embodiments, the reinforced foam structure is less brittle than the closed cell foam is absent the open cell substrate. In one or more embodiments, the composite material created by the open cell substrate and the closed cell foam is a thermal insulator.

The closed cell foam may be any material that expands into the voids of the open cell substrate. Examples of expanding closed cell foam include, but are not limited to, polyurethane foam, polyethylene, ethylene propylene diene terpolymer (“EPDM”), neoprene, polyvinyl chloride (“PVC”), p-phenylenedimaleimide (“PPDM”), foamed aluminum, or windscreen foam.

The closed cell foam is capable of expansion such that when it is initially applied to the open cell substrate, the closed cell foam expands along the contours of the matrix structure of the open cell substrate and fills the open cell voids. In one or more embodiments, the closed cell foam is selectively applied to a portion of the open cells of the open cell substrate to increase the compressive strength of the reinforced foam structure in a specific area. In one or more embodiments, the closed cell foam is disposed within at least about 65 % of the open cells of the substrate. In one or more embodiments, the closed cell foam is expanded within more than about 80% of the open cells of the substrate. In one or more embodiments, the closed cell foam is expanded within at most about 35% of the open cells of the substrate.

The composite material exhibits a greater compressive strength than that of either the open cell substrate or closed cell foam alone which can be exemplified by both the ability of the structure to maintain fasteners and the decreased need for steel within the structure.

For instance, the closed cell foam does not allow for screws to fasten to the closed cell foam directly. In traditional HVAC panels, strength of the panel arises from the closed cell foam bonding to the steel of the liner which does not improve the strength of fasteners attached to the closed cell foam. By adding an open cell substrate into the space where the expanding closed cell foam will occupy, the expanding closed cell foam impregnates itself into the open cell substrate, creating a structure harder than either the open cell foam or the closed cell foam alone. This increases the compressive strength of the panel and, in one or more embodiments, allows fasteners to be secured directly to the panel without the use of additional reinforcements. Advantageously, when an open cell substrate is utilized in conjunction with the closed cell foam, fasteners may be secured directly to the panel assemblies due to the increased strength of the composite material. Further, the use of the composite material may minimize the need for additional support structure such as stiffeners as fasteners can be directly coupled to the composite material.

Additionally, traditional HVAC panels often use heavier gauge sheet metal, gaskets, mechanical inserts (such as Rivnuts and weldnuts), and specialty fasteners to attach components to panel assemblies. The use of additional support structure adds weight to the panel assembly and may cause deformation of the panel assembly depending on what type of fastener or support structure is used. Closed cell foam (absent an open cell substrate) has been utilized to minimize the weight of additional support structures, however, fasteners utilized with the additional support structure often cannot be properly fastened directly to the closed cell foam due to the brittleness of the closed cell foam. To contain the closed cell foam from continuously expanding, steel cladding, stiffeners, or additional support structures are traditionally utilized to encapsulate the closed cell foam which may create a thermal path from the interior of the AHU to the exterior. Such a thermal path can cause the exterior of the AHU to be cold and may create a significant amount of condensate on the outside of the AHU.

The use of the composite material may also advantageously result in the use of less steel cladding in AHU panel assemblies. Historically, before closed cell foam was used as insulation, fiberglass sheet insulation was utilized in AHU panel assemblies. In one or more instances, those panel assemblies required using approximately 60 mm thick steel cladding because the fiberglass sheets did not provide any additional strength to the steel cladding. By switching to closed cell foam, which has insulating properties, the steel cladding can be reduced down to 20 mm thick because the adhesion of the expanding closed cell foam to the steel imparted some additional strength to the panel assembly overall. Not only does the use of less steel cladding drive production costs lower, using less cladding is also a simpler design for use with larger panels.

The use of the composite material within AHU panel assemblies may further improve strength of the panel, increase shear strength of the panel, increase the panel's resistance to fatigue bending, increase bending and compressive loading, improve fatigue strength under cyclic loading, increase the overall ability of the panel to withstand torsional and tensile loads, increase toughness of the panel, increase stiffness of the panel, increase rigidness of the panel, improve the ability of the panel to withhold pressure, decrease panel deformation, decrease leak points within the panel, and decrease production costs through the elimination of fasteners.

As a further advantage, while AHU panel assemblies are typically square or rectangular, the composite material can also create irregular shapes. Because the open cell substrate is flexible, the open cell substrate can be packed into essentially any shape, and then impregnated by the closed cell foam.

Because of the composite material's versatility, the composite material may be selectively coupled to an AHU panel assembly. In one or more embodiments, the composite material may cover the entire surface of a panel assembly. In other embodiments, the composite material may only cover select locations of a panel assembly. For instance, the composite material may only be placed along a perimeter of a panel assembly to strengthen the panel assembly, reduce material thickness, reduce heat transfer, and provide support for fasteners placed along the perimeter of the panel assembly. In one such embodiment, the composite material is placed around the perimeter of a panel assembly with a width of 0.5 inches.

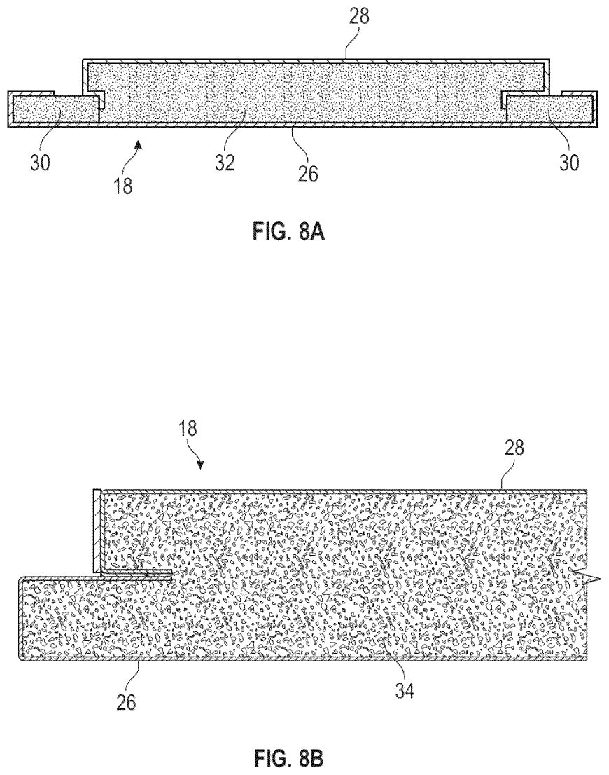

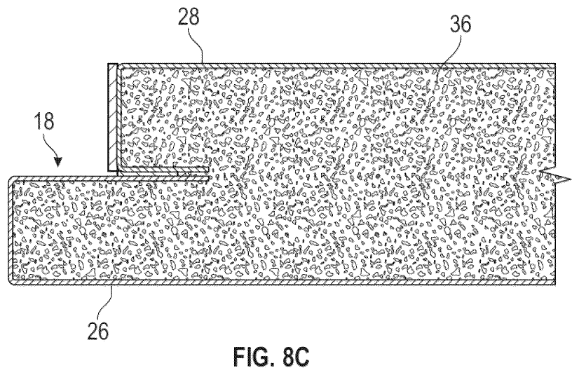

FIG. 8A-C illustrate various embodiments of the application of the composite material on panel assemblies. It will be appreciated that the following embodiments are purely exemplary and other configurations may exist. Each of FIG. 8A-C include a first panel member 26 and a second panel member 28. It will be appreciated that though the below examples illustrate the composite material filling the entire cavity created by the first and second panel members 26, 28, in other embodiments, the composite material may not fill an entire cavity.

FIG. 8A illustrates a panel assembly 18 including a first panel member 26, a second panel member 28, a first composite material 30, and a second composite material 32. The first composite material 30 is disposed between the first and second panel member 26 and 28. The first panel member 26 and the second panel member 28 and the first composite material 30 define a cavity. A closed-cell foam is injected into the panel assembly 18 to substantially fill an entirety of the cavity creating a second composite material 32.

FIG. 8B illustrates a panel assembly 18 including a first panel member 26, a second panel member 28, and a composite material 34. When positioned against one another, the first panel member 26 and the second panel member 28 define a cavity. A closed-cell foam is injected into the panel assembly 18 to substantially fill an entirety of the cavity creating the composite material 34. The cavity formed by the first panel member 26 and the second panel member 28 is filled with the composite material 34 at a known location as a mounting point for fasteners and additional components. In one or more embodiments, the cavity is filled at a location around the perimeter of the first panel member 26 and the second panel member 28.

FIG. 8C illustrates a panel assembly 18 including a first panel member 26, a second panel member 28, and a composite material 36. When positioned against one another, the first panel member 26 and the second panel member 28 define a cavity. A closed-cell foam is injected into the panel assembly 18 to substantially fill an entirety of the cavity creating a composite material 36. The cavity formed by the first panel member 26 and second panel member 28 is partially filled with the composite material 36 at a known location as a panel to block sound but transfer heat. The composite material 36 of FIG. 8C includes aluminum as the open cell substrate. In one or more embodiments, the cavity is filled at a location around the perimeter of the first panel member 26 and the second panel member 28.

In light of the disclosure herein and without limiting the disclosure in any way, in an aspect of the present disclosure, which may be combined with any other aspect listed herein unless specified otherwise a structure for use in an HVAC system includes a composite material having an open cell substrate with open cells and a closed cell foam expanded within at least one or more of the open cells of the substrate to form a composite material. The structure further includes a skin layer covering at least a portion of the composite material. The closed cell foam expands within at least one or more of the open cells of the substrate and provides the composite material with greater compressive strength than the open cell substrate without the closed cell foam.

In another aspect of the present disclosure, which may be combined with any other aspect listed herein unless specified otherwise, the open cell substrate includes at least one of a polymer foam, rubber foam, steel material, a polymer mesh, an expanded aluminum material, or a copper material.

In another aspect of the present disclosure, which may be combined with any other aspect listed herein unless specified otherwise, the structure is fastened to a component of the HVAC system by a fastener, wherein the fastener penetrates the structure and wherein the composite material provides the structure with greater compressive strength than the structure with only the open cell substrate.

In another aspect of the present disclosure, which may be combined with any other aspect listed herein unless specified otherwise, the open cell substrate is a matrix.

In another aspect of the present disclosure, which may be combined with any other aspect listed herein unless specified otherwise, the closed cell foam is a thermal insulator.

In another aspect of the present disclosure, which may be combined with any other aspect listed herein unless specified otherwise, the structure is configured as a panel.

In another aspect of the present disclosure, which may be combined with any other aspect listed herein unless specified otherwise, the structure is configured for use on an air handling unit.

In another aspect of the present disclosure, which may be combined with any other aspect listed herein unless specified otherwise, wherein the closed cell foam is disposed within at least about 65% of the open cells of the substrate.

In another aspect of the present disclosure, which may be combined with any other aspect listed herein unless specified otherwise, the closed cell foam is expanded within more than about 80% of the open cells of the substrate.

In another aspect of the present disclosure, which may be combined with any other aspect listed herein unless specified otherwise, the closed cell foam is expanded within at most about 35% of the open cells of the substrate.

In another aspect of the present disclosure, which may be combined with any other aspect listed herein unless specified otherwise, the closed cell foam is a material selected from the group consisting of polyurethane foam, polyethylene, ethylene propylene diene terpolymer (“EPDM”), neoprene, polyvinyl chloride (“PVC”), p-phenylenedimaleimide (“PPDM”), foamed aluminum, and windscreen foam.

In another aspect of the present disclosure, which may be combined with any other aspect listed herein unless specified otherwise, an HVAC system includes a component and a structure. The structure is attached to the component and includes a composite material having an open cell substrate including open cells and a closed cell foam expanded within at least one or more of the open cells of the substrate to form a composite material. The structure further includes a skin layer covering at least a portion of the composite material.

In another aspect of the present disclosure, which may be combined with any other aspect listed herein unless specified otherwise, the closed cell foam expanded within at least one or more of the open cells of the substrate provides the composite material with greater compressive strength than the open cell foam without the closed cell foam.

In another aspect of the present disclosure, which may be combined with any other aspect listed herein unless specified otherwise, the open cell substrate includes at least one of a polymer foam, rubber foam, steel material, a polymer mesh, an expanded aluminum material, or a copper material.

In another aspect of the present disclosure, which may be combined with any other aspect listed herein unless specified otherwise, the structure is configured as a panel and the fastener penetrates the panel.

In another aspect of the present disclosure, which may be combined with any other aspect listed herein unless specified otherwise, the open cell substrate is a matrix.

In another aspect of the present disclosure, which may be combined with any other aspect listed herein unless specified otherwise, the closed cell foam is a thermal insulator.

In another aspect of the present disclosure, which may be combined with any other aspect listed herein unless specified otherwise, the closed cell foam is disposed within at least about 65% of the open cells of the substrate.

In another aspect of the present disclosure, which may be combined with any other aspect listed herein unless specified otherwise, the closed cell foam is expanded within more than about 80% of the open cells of the substrate.

In another aspect of the present disclosure, which may be combined with any other aspect listed herein unless specified otherwise, the closed cell foam is expanded within at most about 35% of the open cells of the substrate.

The application method of the closed cell foam within the open cell substrate may vary. In one or more embodiments, the closed cell foam is injected into the open cell substrate. In other embodiments, the closed cell foam is sprayed or poured into the open cell substrate.

In understanding the scope of the present invention, the term “comprising” and its derivatives, as used herein, are intended to be open ended terms that specify the presence of the stated features, elements, components, groups, integers, and/or steps, but do not exclude the presence of other unstated features, elements, components, groups, integers and/or steps. The foregoing also applies to words having similar meanings such as the terms, “including”, “having” and their derivatives. Also, the terms “part,” “section,” “portion,” “member” or “element” when used in the singular can have the dual meaning of a single part or a plurality of parts.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements.

The term “configured” as used herein to describe a component, section or part of a device includes hardware and/or software that is constructed and/or programmed to carry out the desired function.

The terms of degree such as “substantially”, “about” and “approximately” as used herein mean a reasonable amount of deviation of the modified term such that the end result is not significantly changed.

While the aspects of the present disclosure may be susceptible to various modifications and alternative forms, specific embodiments have been shown by way of example in the drawings and have been described in detail herein. But it should be understood that the invention is not intended to be limited to the particular forms disclosed. Rather, the invention is to cover all modifications, equivalents, and alternatives falling within the spirit and scope of the invention as defined by the following appended claims.

What is claimed is:

1. A structure for use in an HVAC system, comprising:
a composite material comprising:
an open cell substrate comprising open cells;
a closed cell foam expanded within at least one or more of the open cells of the substrate to form a composite material; and
a skin layer covering at least a portion of the composite material,
wherein the closed cell foam expanded within at least one or more of the open cells of the substrate provides the composite material with greater compressive strength than the open cell substrate without the closed cell foam.

2. The structure of claim 1, wherein the open cell substrate comprises at least one of a polymer foam, rubber foam, steel material, a polymer mesh, an expanded aluminum material, or a copper material.

3. The structure of claim 1, wherein the structure is fastened to a component of the HVAC system by a fastener penetrating the structure and wherein the composite material provides the structure with greater compressive strength than the structure with only the open cell substrate.

4. The structure of claim 1, wherein the open cell substrate comprises a matrix.

5. The structure of claim 1, wherein the closed cell foam comprises a thermal insulator.

6. The structure of claim 1, wherein the structure is configured as a panel.

7. The structure of claim 1, wherein the HVAC system comprises an air handling unit.

8. The structure of claim 1, wherein the closed cell foam is disposed within at least about 65% of the open cells of the substrate.

9. The structure of claim 1, wherein the closed cell foam is expanded within more than about 80% of the open cells of the substrate.

10. The structure of claim 1, wherein the closed cell foam is expanded within at most about 35% of the open cells of the substrate.

11. The structure of claim 1, wherein the closed cell foam is a material selected from the group consisting of polyurethane foam, polyethylene, ethylene propylene diene terpolymer (“EPDM”), neoprene, polyvinyl chloride (“PVC”), p-phenylenedimaleimide (“PPDM”), foamed aluminum, and windscreen foam.

12. An HVAC system, comprising:
a component;
a structure attached to the component and comprising:
a composite material comprising an open cell substrate comprising open cells and a closed cell foam expanded within at least one or more of the open cells of the substrate; and
a skin layer covering at least a portion of the composite material.

13. The system of claim 12, wherein the closed cell foam expanded within at least one or more of the open cells of the substrate provides the composite material with greater compressive strength than the open cell foam without the closed cell foam.

14. The system of claim 12, wherein the open cell substrate comprises at least one of a polymer foam, rubber foam, steel material, a polymer mesh, an expanded aluminum material, or a copper material.

15. The system of claim 12, wherein the structure is configured as a panel and wherein the panel is connected a frame by a fastener, wherein the fastener penetrates the panel.

16. The system of claim 12, wherein the open cell substrate comprises a matrix.

17. The system of claim 12, wherein the closed cell foam comprises a thermal insulator.

18. The system of claim 12, wherein the closed cell foam is disposed within at least about 65% of the open cells of the substrate.

19. The system of claim 12, wherein the closed cell foam is expanded within more than about 80% of the open cells of the substrate.

20. The system of claim 12, wherein the closed cell foam is expanded within at most about 35% of the open cells of the substrate.
